(19) United States
(12) Patent Application Publication
(10) Pub. No.: US 2026/0121985 A1
(43) Pub. Date: Apr. 30, 2026

(54) DATA MESSAGE TRANSMISSION CONTROL METHOD, SYSTEM AND APPARATUS, AND NONTRANSITORY READABLE STORAGE MEDIUM

(71) Applicant: Suzhou Metabrain Intelligent Technology Co., Ltd., Suzhou, Jiangsu (CN)

(72) Inventors: Fuli YUAN, Suzhou, Jiangsu (CN); Xiang CHEN, Suzhou, Jiangsu (CN); Qingfei ZHOU, Suzhou, Jiangsu (CN); Shaomei WANG, Suzhou, Jiangsu (CN); Xiaojiang CHEN, Suzhou, Jiangsu (CN); Changlei REN, Suzhou, Jiangsu (CN)

(21) Appl. No.: 19/150,952

(22) PCT Filed: Dec. 13, 2023
(86) PCT No.: PCT/CN2023/138566

§ 371 Date: Jul. 25, 2025

(30) Foreign Application Priority Data
Mar. 13, 2023 (CN) 202310234606.0

(51) Int. Cl. H04L 47/125; H04L 12/46; H04L 47/215

(52) U.S. Cl. CPC H04L 47/125; H04L 12/4641; H04L 47/215

(57) ABSTRACT

Provided in the embodiments of the present application are a data message transmission control method, system and apparatus, and a non-transitory readable storage medium. The method includes: acquiring a plurality of target provider edges connected to the same customer edge; generating a load balancing instruction for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and issuing the load balancing instructions to the corresponding target provider edges.

### CROSS-REFERENCE TO RELATED APPLICATION

This application claims priority to Chinese Patent Application No. 202310234606.0, filed on Mar. 13, 2023 in China National Intellectual Property Administration and entitled “Data Message Transmission Control Method, System and Apparatus, and Non-transitory Readable Storage Medium”, which is hereby incorporated by reference in its entirety.

### FIELD

Embodiments of the present application relate to the field of computers, in particular to a data message transmission control method, system and apparatus, and a non-transitory readable storage medium.

### BACKGROUND

In the current Ethernet Virtual Private Network (EVPN) scenario, a Customer Edge (CE) is connected to a plurality of Provider Edges (PEs) by a plurality of Ethernet links. In order to avoid network resource waste caused by receiving repeated flow from the plurality of PEs by the CE, a voting mechanism of a Designated Forwarder (DF) is introduced to the EVPN scenario.

Type-4 (Network Layer Reachability Information (NLRI) type) routing in a BGP EVPN (a new NLRI is defined on the basis of a BGP, i.e., a border gateway protocol) selects a DF in a Virtual Local Area Network (VLAN), data in the VLAN might only be forwarded by the DF, and the remaining PEs cannot forward Broadcast Unicast Multicast (BUM) data in the VLAN. In such a way, load balance between VLANs might be achieved; however, a flow in the same VLAN might only be forwarded by one link between CEs or DFs, which will result in load imbalance of link resources; and when a link resource selected for forwarding is poor, the operation of services in the entire link will be affected if the link is used for forwarding.

For the problem of relatively low transmission efficiency of data messages in the related art, no effective solution has been proposed.

### SUMMARY

Embodiments of the present application provide a data message transmission control method, system and apparatus, and a non-transitory readable storage medium so as to at least solve the problem of relatively low transmission efficiency of data messages in the related art.

According to a first aspect, provided is a data message transmission control method being applied to an Ethernet virtual private network, the method including:
acquiring a plurality of target provider edges connected to the same customer edge;
generating a load balancing instruction for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and
issuing the load balancing instructions to the corresponding target provider edges, wherein the target provider edges are configured for forwarding the target data messages to the customer edge by using the received load balancing instructions.

In an exemplary embodiment, the acquiring a plurality of target provider edges connected to the same customer edge includes:
acquiring all provider edges connected to the customer edge as candidate provider edges; and
screening the plurality of target provider edges from the candidate provider edges according to a link state of each candidate provider edge, wherein the link state is a network state of a connecting link between each candidate provider edge and the customer edge.

In an exemplary embodiment, the screening the plurality of target provider edges from the candidate provider edges according to a link state of each candidate provider edge includes:
determining a link parameter corresponding to each candidate provider edge as the link state according to network parameters reported by each candidate provider edge, wherein the network parameters include at least one of following parameters: a bandwidth utilization rate, a latency, a jitter and a packet loss rate, and the smaller the link parameter is, the better the link state is; and
screening corresponding provider edges with link parameters being smaller than or equal to a parameter threshold as the plurality of target provider edges from the candidate provider edges.

In an exemplary embodiment, the determining a link parameter corresponding to each candidate provider edge as the link state according to network parameters reported by each candidate provider edge includes:
receiving the network parameters reported by each candidate provider edge based on a mirrored message, wherein the network parameters include: the bandwidth utilization rate, the latency, the jitter and the packet loss rate; and
calculating a weighted sum of the network parameters as the link parameter, wherein a weight of each network parameter is directly proportional to a degree of impact of each network parameter on the network state.

In an exemplary embodiment, the receiving the network parameters reported by each candidate provider edge based on a mirrored message includes one of the following steps:
receiving the network parameters reported by each candidate provider edge based on the mirrored message and according to a target period;
sending a reporting instruction to each candidate provider edge; and receiving the network parameters reported by each candidate provider edge in response to the reporting instruction and based on the mirrored message.

In an exemplary embodiment, the acquiring all provider edges connected to the customer edge as candidate provider edges includes:
receiving an Ethernet network segment number reported, based on a start message, by each provider edge that has established communication connection; and
determining provider edges having the same Ethernet network segment number as all the provider edges connected to the same customer edge to obtain the candidate provider edges.

In an exemplary embodiment, the generating a load balancing instruction for each target provider edge amongst the plurality of target provider edges includes:
generating a target number of load balancing tokens, wherein the target number is the number of the plurality of target provider edges; and
generating the load balancing instruction carrying the target number and the load balancing tokens, wherein the load balancing instruction is used for instructing each target provider edge to forward, according to message information carried by received data messages to be transmitted, the target number and the load balancing tokens, target data messages matched with the load balancing tokens amongst the data messages to be transmitted.

In an exemplary embodiment, the generating a target number of load balancing tokens includes:
determining the number of the plurality of target provider edges to obtain the target number M; and
generating a natural number ranging from 0 to M-1 as the target number of the load balancing tokens.

In an exemplary embodiment, the issuing the load balancing instructions to the corresponding target provider edges includes:
packaging the load balancing instructions as signaling messages; and
issuing the signaling messages to the corresponding target provider edges.

In an exemplary embodiment, the target provider edges are configured for determining message identifiers according to the message information and the target number carried in the load balancing instruction; matching the message identifiers with the load balancing tokens carried in the load balancing instruction; and determining the data messages to be transmitted as the target data messages under the condition that the message identifiers are successfully matched with the load balancing tokens.

In an exemplary embodiment, the target provider edges are configured for calculating remainders obtained by dividing the message information by the target number as the message identifiers; comparing the remainders with the load balancing tokens; and determining, under the condition that the remainders are consistent with the load balancing tokens by comparison, that the message identifiers are successfully matched with the load balancing tokens.

According to a second aspect, further provided is a data message transmission control method being applied to target provider edges in an Ethernet virtual private network, the method including:
receiving data messages to be transmitted, wherein the data messages to be transmitted belong to the same virtual local area network;
extracting message information from the data messages to be transmitted;
acquiring, according to the message information and a load balancing instruction, target data messages matched with the target provider edges amongst the data messages to be transmitted, wherein the load balancing instruction is generated and issued by a monitoring server of the Ethernet virtual private network; and
forwarding the target data messages to a customer edge connected to the target provider edges.

In an exemplary embodiment, the acquiring, according to the message information and a load balancing instruction, target data messages matched with the target provider edges amongst the data messages to be transmitted includes:
determining message identifiers according to the message information and a target number carried in the load balancing instruction, wherein the target number is the number of the plurality of target provider edges screened by the monitoring server and used for forwarding the data messages to be transmitted;
matching the message identifiers with load balancing tokens carried in the load balancing instruction; and
determining the data messages to be transmitted as the target data messages under the condition that the message identifiers are successfully matched with the load balancing tokens.

In an exemplary embodiment, the determining message identifiers according to the message information and a target number carried in the load balancing instruction includes: calculating remainders obtained by dividing the message information by the target number as the message identifiers, wherein the message information is obtained by performing a hash operation on original message data in the data messages to be transmitted; and
the matching the message identifiers with load balancing tokens carried in the load balancing instruction includes: comparing the remainders with the load balancing tokens, wherein the number of the load balancing tokens is a natural number ranging from 0 to M-1 generated by the monitoring server, and M is the target number; and determining, under the condition that the remainders are consistent with the load balancing tokens by comparison, that the message identifiers are successfully matched with the load balancing tokens.

In an exemplary embodiment, after the matching the message identifiers with load balancing tokens carried in the load balancing instruction, the method further includes:
discarding the data messages to be transmitted under the condition that the message identifiers fail to be matched with the load balancing tokens.

In an exemplary embodiment, before the acquiring, according to the message information and a load balancing instruction, target data messages matched with the target provider edges amongst the data messages to be transmitted, the method further includes:
reporting network parameters to the monitoring server based on a mirrored message, wherein the network parameters include at least one of following parameters: a bandwidth utilization rate, a latency, a jitter and a packet loss rate; and
receiving the load balancing instruction issued by the monitoring server in response to the network parameters and based on a signaling message.

In an exemplary embodiment, the reporting network parameters to the monitoring server based on a mirrored message includes one of the following steps:
reporting the network parameters based on the mirrored message and according to a target period;
receiving a reporting instruction sent by the monitoring server, and making a response to the reporting instruction to report the network parameters based on the mirrored message.

In an exemplary embodiment, before the acquiring, according to the message information and a load balancing instruction, target data messages matched with the target provider edges amongst the data messages to be transmitted, the method further includes:
establishing communication connection with the monitoring server; and
reporting an Ethernet network segment number to the monitoring server based on a start message.

In an exemplary embodiment, the extracting message information from the data messages to be transmitted includes:
extracting original message data following a VXLAN header field from the data messages to be transmitted; and
performing the hash operation on the original message data to obtain the message information.

In an exemplary embodiment, the load balancing instruction is generated and issued by the monitoring server of the Ethernet virtual private network according to the following steps: acquiring all provider edges connected to the customer edge as candidate provider edges; screening the plurality of target provider edges from the candidate provider edges according to a link state of each candidate provider edge, wherein the link state is a network state of a connecting link between each candidate provider edge and the customer edge; generating a target number of load balancing tokens, wherein the target number is the number of the plurality of target provider edges; and generating the load balancing instruction carrying the target number and the load balancing tokens, wherein the load balancing instruction is used for instructing each target provider edge to forward, according to message information carried by received data messages to be transmitted, the target number and the load balancing tokens, target data messages matched with the load balancing tokens amongst the data messages to be transmitted.

In an exemplary embodiment, the generating a target number of load balancing tokens includes: determining the number of the plurality of target provider edges to obtain the target number M; and generating a natural number ranging from 0 to M-1 as the target number of the load balancing tokens.

According to a third aspect, provided is a data message transmission control system being applied to an Ethernet virtual private network, the system including a monitoring server of the Ethernet virtual private network and a plurality of provider edges,
the monitoring server being respectively connected to the plurality of provider edges, and the plurality of provider edges being connected to the same customer edge;
the monitoring server being configured for acquiring a plurality of target provider edges amongst the plurality of provider edges; generating a load balancing instruction for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and issuing the load balancing instructions to the corresponding target provider edges; and
the target provider edges being configured for receiving data messages to be transmitted, wherein the data messages to be transmitted belong to the same virtual local area network; extracting message information from the data messages to be transmitted; acquiring, according to the message information and the load balancing instruction, target data messages matched with the target provider edges amongst the data messages to be transmitted; and forwarding the target data messages to the customer edge.

According to a fourth aspect, provided is a data message transmission control apparatus being applied to an Ethernet virtual private network, the apparatus including:
a first acquisition module configured for acquiring a plurality of target provider edges connected to the same customer edge;
a generation module configured for generating a load balancing instruction for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and
an issuing module configured for issuing the load balancing instructions to the corresponding target provider edges, wherein the target provider edges are configured for forwarding the target data messages to the customer edge by using the received load balancing instructions.

According to a fifth aspect, provided is a data message transmission control apparatus being applied to target provider edges in an Ethernet virtual private network, the apparatus including:
a first receiving module configured for receiving data messages to be transmitted, wherein the data messages to be transmitted belong to the same virtual local area network;
an extraction module configured for extracting message information from the data messages to be transmitted;
a second acquisition module configured for acquiring, according to the message information and a load balancing instruction, target data messages matched with the target provider edges amongst the data messages to be transmitted, wherein the load balancing instruction is generated and issued by a monitoring server of the Ethernet virtual private network; and
a forwarding module configured for forwarding the target data messages to a customer edge connected to the target provider edges.

According to a sixth aspect, further provided is a computer non-transitory readable storage medium, the computer non-transitory readable storage medium having a computer program stored thereon, wherein the computer program is configured for performing the steps in any one of the above-mentioned method embodiments when operating.

According to a seventh aspect, further provided is an electronic device, including a memory and a processor, the memory having a computer program stored thereon, and the processor being configured for operating the computer program so as to perform the steps in any one of the above-mentioned method embodiments.

According to the present application, a plurality of target provider edges connected to the same customer edge are acquired; a load balancing instruction is generated for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and the load balancing instructions are issued to the corresponding target provider edges used for forwarding the target data messages to the customer edge by using the received load balancing instructions. That is, the plurality of target provider edges connected to the same customer edge are used as devices allowing to forward data messages in the same virtual local area network. The load balancing instruction is generated for each target provider edge, wherein the load balancing instruction instructs each target provider edge to forward, according to the message information carried by the received data messages to be transmitted and the load balancing instruction, a target data message matched with each target provider edge, whereby the data messages in the same virtual local area network might be distributed to the different target provider edges for forwarding, and load balancing of the data messages in the same virtual local area network is achieved. Therefore, the problem of relatively low transmission efficiency of data messages might be solved, and the effect of improving the transmission efficiency of the data messages might be achieved.

### BRIEF DESCRIPTION OF THE DRAWINGS

FIG. 1 is a hardware structural block diagram of a mobile terminal in a data message transmission control method in an embodiment of the present application;

FIG. 2 is a first process diagram of data message transmission control according to an embodiment of the present application;

FIG. 3 is a process diagram of issuing load balancing tokens according to an embodiment;

FIG. 4 is a first process diagram of load-balanced data message transmission according to an embodiment;

FIG. 5 is a second process diagram of data message transmission control according to an embodiment of the present application;

FIG. 6 is a schematic diagram of a traditional VXLAN message according to an embodiment;

FIG. 7 is a process diagram of determining target data messages of target provider edges according to an embodiment;

FIG. 8 is a second process diagram of load-balanced data message transmission

### According to an Embodiment;

FIG. 9 is a structural block diagram of a data message transmission control system according to an embodiment of the present application;

FIG. 10 is a structural block diagram of a data message transmission control apparatus applied to an Ethernet virtual private network according to an embodiment of the present application; and

FIG. 11 is a structural block diagram of a data message transmission control apparatus applied to target provider edges according to an embodiment of the present application.

### DETAILED DESCRIPTION

Embodiments of the present application will be described in detail hereinafter with reference to the drawings and in conjunction with embodiments.

It should be noted that terms such as “first” and “second” in the description and claims of the present application and the above-mentioned drawings are used for distinguishing similar objects, but are unnecessarily used for describing a specific sequential or chronological order.

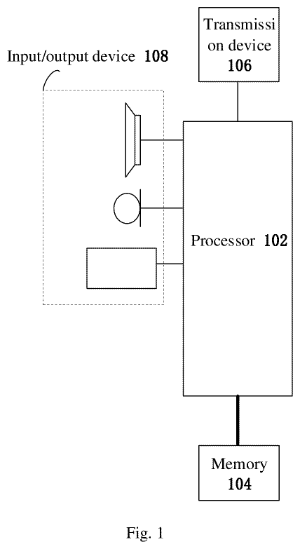

Method embodiments provided in the embodiments of the present application may be performed in a mobile terminal, a computer terminal or a similar arithmetic device. With operation on the mobile terminal as an example, FIG. 1 is a hardware structural block diagram of a mobile terminal in a data message transmission control method in an embodiment of the present application. As shown in FIG. 1, the mobile terminal may include one or more (one processor is only shown in FIG. 1) processors 102 (the processor 102 may include, but is not limited to a Microcontroller Unit (MCU) or a Field Programmable Gate Array (FPGA) and other processing apparatuses) and a memory 104 configured for storing data, wherein the above-mentioned mobile terminal may further include a transmission device 106 configured for achieving a transmission function and an input/output device 108. It might be understood by those ordinarily skilled in the art that the structure shown in FIG. 1 is only schematic, and is not intended to limit the structure of the above-mentioned mobile terminal. For example, the mobile terminal may further include more or fewer components than those shown in FIG. 1, or a configuration different from that in FIG. 1.

The memory 104 may be configured for storing a computer program, such as a software program and module of application software, such as a computer program corresponding to a data message transmission control method in an embodiment of the present application. The processor 102 operates the computer program stored in the memory 104, thus performing various function applications and data processing, i.e., implementing the above-mentioned method. The memory 104 may include a high-speed random access memory, and may further include a non-transitory memory, such as one or more magnetic storage apparatuses, flash memories, or other non-transitory solid-state memories. In some examples, the memory 104 may include memories remotely disposed relative to the processor 102, and these remote memories may be connected to the mobile terminal by a network. Examples of the above-mentioned network include, but are not limited to the Internet, the Intranet, a local area network, a mobile communication network and combinations thereof.

The transmission device 106 is configured for receiving or sending data by a network. The examples of the above-mentioned network may include a wireless network provided by a communication provider of the mobile terminal. In an example, the transmission device 106 includes a Network Interface Controller (NIC), which might be connected to other network devices by a base station, thus communicating with the Internet. In an example, the transmission device 106 may be a Radio Frequency (RF) module configured for wireless communication with the Internet.

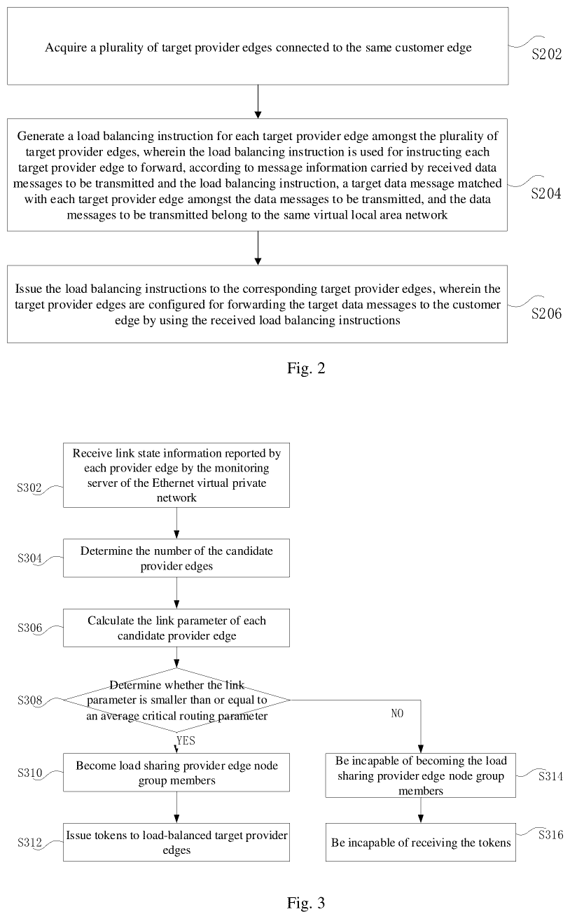

This embodiment provides a data message transmission control method applied to an Ethernet virtual private network, FIG. 2 is a first process diagram of data message transmission control according to an embodiment of the present application, as shown in FIG. 2, the process includes the following steps:
step S202, acquiring a plurality of target provider edges connected to the same customer edge;
step S204, generating a load balancing instruction for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and
step S206, issuing the load balancing instructions to the corresponding target provider edges, wherein the target provider edges are configured for forwarding the target data messages to the customer edge by using the received load balancing instructions.

According to the above-mentioned steps, the plurality of target provider edges connected to the same customer edge are used as devices allowing to forward data messages in the same virtual local area network. The load balancing instruction is generated for each target provider edge, wherein the load balancing instruction instructs each target provider edge to forward, according to the message information carried by the received data messages to be transmitted and the load balancing instruction, a target data message matched with each target provider edge, whereby the data messages in the same virtual local area network might be distributed to the different target provider edges for forwarding, and load balancing of the data messages in the same virtual local area network is achieved. Therefore, the problem of relatively low transmission efficiency of data messages might be solved, and the effect of improving the transmission efficiency of the data messages might be achieved.

Alternatively, in this embodiment, the above-mentioned EVPN (Ethernet Virtual Private Network) is a Virtual Private Network (VPN) technology for large-scale layer 2 network interconnection in a data center. The EVPN technology adopts a mechanism similar to a Border Gateway Protocol/Multiprotocol Label Switching Internet Protocol Virtual Private Network (BGP/MPLS IP VPN), the BGP EVPN defines new Network Layer Reachability Information (NLRI) on the basis of a Border Gateway Protocol (BGP), and BGP EVPN NLRI defines five new BGP EVPN routing types.

Alternatively, in this embodiment, the above-mentioned data message transmission control method may be, but not limited to be applied to a device having a provider edge control function in the Ethernet virtual private network, such as a monitoring server of the Ethernet virtual private network; or the method may be further, but not limited to be applied to a certain provider edge amongst the plurality of provider edges connected to the customer edge.

In the technical solution provided in above-mentioned step S202, the above-mentioned customer edge may be connected to the plurality of provider edges by using, but not limited to a plurality of Ethernet links, and the above-mentioned customer edge may be, but not limited to, configured for receiving the data messages sent by the plurality of provider edges connected thereto.

Alternatively, in this embodiment, the above-mentioned provider edge may be, but not limited to be configured for forwarding the data messages in the virtual local area network to the customer edge.

Alternatively, in this embodiment, it may be, but not limited to that the provider edges connected to the same customer edge by the Ethernet links are determined as the target provider edges, for example, all the provider edges connected to the same customer edge are used as the plurality of target provider edges. Or, parts of provider edges may be screened as the plurality of target provider edges from all the provider edges connected to the same customer edge.

In an exemplary embodiment, the plurality of target provider edges connected to the same customer edge may be acquired by adopting, but not limited to the following ways: acquiring all provider edges connected to the customer edge as candidate provider edges; and screening the plurality of target provider edges from the candidate provider edges according to a link state of each candidate provider edge, wherein the link state is a network state of a connecting link between each candidate provider edge and the customer edge.

Alternatively, in this embodiment, the link state of the connecting link between each candidate provider edge and the customer edge may be determined according to, but not limited to a network state in which the data messages are transmitted by the connecting link, for example, when the network state of the connecting link between each candidate provider edge and the customer edge is good, it is regarded that the efficiency that the data messages are transmitted by the connecting link of each candidate provider edge is relatively high and the link state is good. Or, when the network state of the connecting link between each candidate provider edge and the customer edge is relatively poor, it is regarded that the efficiency that the data messages are transmitted by the connecting link of each candidate provider edge is relatively low and the link state is relatively poor.

Alternatively, in this embodiment, provided is a screening process for the target provider edges. The target provider edges may be determined amongst the candidate provider edges according to, but not limited to the link state of the connecting link, for example, when it is detected that the network state of the connecting link is relatively stable, that is, the connecting link might complete the transmission of a target number of data messages within a target time, it may be determined that the link state of this connecting link is good, and it may be, but not limited to that this connecting link having the good link state is determined as the target provider edge. Or, when it is detected that the network state of the connecting link greatly fluctuates, that is, it is difficult for the connecting link to complete the transmission of the data messages, it may be determined that the link state of this connecting link is relatively poor, and it may be, but not limited to that this connecting link having the relatively poor link state is not determined as the target provider edge.

In an exemplary embodiment, the plurality of target provider edges may be screened from the candidate provider edges according to a link state of each candidate provider edge by adopting, but not limited to the following ways: determining a link parameter corresponding to each candidate provider edge as the link state according to network parameters reported by each candidate provider edge, wherein the network parameters include at least one of following parameters: a bandwidth utilization rate, a latency, a jitter and a packet loss rate, and the smaller the link parameter is, the better the link state is; and screening corresponding provider edges with link parameters being smaller than or equal to a parameter threshold as the plurality of target provider edges from the candidate provider edges.

Alternatively, in this embodiment, the link parameter of each candidate provider edge may be determined by acquiring, but not limited to acquiring one or more network parameters, including the bandwidth utilization rate, the latency, the jitter and the packet loss rate, etc., of each candidate provider edge, and thus, the link state of the connecting link is determined, for example, the link parameter of each candidate provider edge is calculated according to the bandwidth utilization rate, the latency, the jitter and the packet loss rate under the condition that the network parameters, including the bandwidth utilization rate, the latency, the jitter and the packet loss rate, etc. of each candidate provider edge are acquired, the smaller the link parameter is, the better the link state of the connecting link (that is, the link state of the connecting link of each candidate provider edge is good), and it may be, but not limited to that the link parameter is compared with a set threshold for determining the link state to determine that the link state in which the link parameter is smaller than the threshold is relatively good.

Alternatively, in this embodiment, the link parameter is used for instructing a working state of the connecting link corresponding to each candidate provider edge. The smaller the numerical value of the link parameter is, the better the working state of the corresponding connecting link, otherwise, the larger the numerical value is, the working state of the corresponding connecting link is poorer.

Alternatively, in this embodiment, the parameter threshold may be defined according to, but not limited to network states of connecting links among all the candidate provider edges connected to the same customer edge, and the parameter threshold may be, but not limited to, used for screening connecting links, that are in good link states, between the customer edge and each candidate provider edge.

Alternatively, in this embodiment, with the network parameters including the bandwidth utilization rate, the latency, the jitter and the packet loss rate as an example, the link parameter of the connecting link may be determined according to, but not limited to the bandwidth utilization rate, the latency, the jitter and the packet loss rate of the connecting link, for transmitting the data messages, between the customer edge and each candidate provider edge, the link parameter is compared with the parameter threshold defined according to the network state of the connecting link among all the candidate provider edges connected to the same customer edge, and provider edges of which the link parameters are smaller than or equal to the parameter threshold may be determined as the target provider edges.

In an exemplary embodiment, the link parameter corresponding to each candidate provider edge may be determined as the link state according to network parameters reported by each candidate provider edge by adopting, but not limited to the following ways: receiving the network parameters reported by each candidate provider edge based on a mirrored message, wherein the network parameters include: the bandwidth utilization rate, the latency, the jitter and the packet loss rate; and calculating a weighted sum of the network parameters as the link parameter, wherein a weight of each network parameter is directly proportional to a degree of impact of each network parameter on the network state.

Alternatively, in this embodiment, the above-mentioned mirrored message may be, but not limited to a data message defined between each provider edge and the monitoring server of the Ethernet virtual private network and used for reporting the network parameters, collected by the provider edge, of the connecting link between the provider edge and the customer edge.

Alternatively, in this embodiment, the mirrored message may be, but not limited to be sampled within a certain period, the sampling period of the mirrored message may be, but not limited to be adjustable.

Alternatively, in this embodiment, weights of the network parameters may be, but not limited to be used for instructing the degree of impact of the bandwidth utilization rate, the latency, the jitter and the packet loss rate on the network state. Under the condition that there are a plurality of network parameters, it may be, but not limited to that the weights of all network parameters are defined to be the same, for example, the weight p1 of the bandwidth utilization rate=the weight p2 of the latency=the weight p3 of the jitter=the weight p4 of the packet loss rate. Or, under the condition that there are a plurality of network parameters, it may be, but not limited to that the weights of all the network parameters are defined to be different, for example, the weight p1 of the bandwidth utilization rate≠the weight p2 of the latency≠the weight p3 of the jitterthe weight p4 of the packet loss rate.

Alternatively, in this embodiment, it may be, but not limited to that the weighted sums of all the network parameters are used as the link parameters of the corresponding candidate provider edges, for example, with the network parameters including a bandwidth utilization rate k1, a latency k2, a jitter k3 and a packet loss rate k4 and the corresponding weights are the weight p1 of the bandwidth utilization rate, the weight p2 of the latency, the weight p3 of the jitter and the weight p4 of the packet loss rate as an example, the link parameters of the corresponding candidate provider edges may be, but not limited to, equal to ΣJ=(k1p1+k2p2+k3p3+k4p4)*100%.

In an exemplary embodiment, the network parameters reported by each candidate provider edge based on the mirrored message may be received by adopting, but not limited to the following ways: receiving the network parameters reported by each candidate provider edge based on the mirrored message and according to a target period; sending a reporting instruction to each candidate provider edge; and receiving the network parameters reported by each candidate provider edge in response to the reporting instruction and based on the mirrored message.

Alternatively, in this embodiment, the above-mentioned target period is used for instructing a time interval of two adjacent times when the candidate provider edges report the collected network parameters to the monitoring server of the Ethernet virtual private network, and the target period may be, but not limited to be adjustable, for example, the network parameters may be reported to the monitoring server of the Ethernet virtual private network based on the mirrored message every other, but not limited to 300 s. Or, the network parameters may be reported to the monitoring server of the Ethernet virtual private network based on the mirrored message every other, but not limited to 400 s.

Alternatively, in this embodiment, each candidate provider edge may be instructed by using, but not limited to the reporting instruction to report the network parameters based on the mirrored message. That is, it may be, but not limited to that each candidate provider edge reports the network parameters to the monitoring server of the Ethernet virtual private network in response to the reporting instruction. For example, each candidate provider edge monitors the bandwidth utilization rate, the latency, the jitter, the packet loss rate and other data of the connecting link between the candidate provider edge and the corresponding customer edge in real time. However, the candidate provider edge may be, but not limited to be configured for recording and calculating the bandwidth utilization rate, the latency, the jitter, the packet loss rate and other data of the connecting link at the time, and when the target period is reached, the candidate provider edge reports the network parameters including the bandwidth utilization rate, the latency, the jitter, the packet loss rate and other data to the monitoring server based on the mirrored message.

In an exemplary embodiment, all the provider edges connected to the customer edge may be acquired as the candidate provider edges by adopting, but not limited to the following ways: receiving an Ethernet network segment number reported, based on a start message, by each provider edge that has established communication connection; and determining provider edges having the same Ethernet network segment number as all the provider edges connected to the same customer edge to obtain the candidate provider edges.

Alternatively, in this embodiment, the communication connection between each provider edge and the monitoring server of the Ethernet virtual private network may be established by adopting, but not limited to the following ways. For example, with the Ethernet virtual private network being configured in the network as an example, the customer edge and the provider edges are configured with the same monitoring server, the provider edges also establish a BGP neighborhood relationship (i.e., communication connection) with the monitoring server while establishing a BGP neighborhood relationship thereamong, and the provider edges and the monitoring server may be, but not limited to be defined to include message data of start messages (used for the provider edges to report their Ethernet network segment numbers and other information to the monitoring server), mirrored messages (used for reporting the network parameters, collected by the provider edges, of the connecting link between each provider edge and the customer edge to the monitoring server) and signaling messages (used for issuing an instruction from the monitoring server to the provider edges), and it may be, but not limited to that the start messages, the mirrored messages and the signaling messages are packaged into a BGP update (message information in an update format) message for transmission.

Alternatively, in this embodiment, the above-mentioned Ethernet network segment numbers may be, but not limited to be used for instructing numbers of target provider edges connected to the same customer edge amongst the plurality of provider edges, that is, when the Ethernet network segment numbers of the plurality of provider edges are the same, it may be determined that provider edges having the same Ethernet network segment number are connected to the same customer edge.

Alternatively, in this embodiment, the above-mentioned start messages are used for the provider edges to report their Ethernet network segment numbers and other information to the monitoring server. The start messages may be, but not limited to first message data sent after a Transmission Control Protocol (TCP) connection is established between each provider edge and the monitoring server, and the start messages are used for identifying the provider edges having the same Ethernet network segment number as the same redundant backup group.

Alternatively, in this embodiment, according to, but not limited to the Ethernet network segment numbers reported by all the provider edges establishing communication connection with the monitoring server of the Ethernet virtual private network, when the Ethernet network segment numbers of the plurality of provider edges are the same, it may be determined that the provider edges having the same Ethernet network segment number are connected to the same customer edge. At the time, it may be, but not limited to that all the provider edges connected to the same customer edge are determined as the candidate provider edges.

In the technical solution provided in above-mentioned step S204, the above-mentioned load balancing instruction may be, but not limited to be used for instructing each target provider edge amongst the plurality of target provider edges to be matched with a target data message amongst a plurality of message information, that is, the data messages to be transmitted may be, but not limited to data messages carrying the message information, it may be, but not limited to that a certain section of data message amongst the data messages to be transmitted is determined as the message information, and target data messages matched with the target provider edges may be determined according to, but not limited to the load balancing instructions and the message information.

Alternatively, in this embodiment, there may be, but not limited to a plurality of target data messages matched with the target provider edges, for example, with the target provider edges including a target PE1 and a target PE2, and the data messages to be transmitted including a data message A to be transmitted, a data message B to be transmitted, a data message C to be transmitted and a data message D to be transmitted as an example, the target data messages matched with the target PE1 may include, but not limited to the data message A to be transmitted and the data message B to be transmitted, the target data messages matched with the target PE2 may include, but not limited to the data message C to be transmitted and the data message D to be transmitted, and each of the target PE1 and the target PE2 is provided with two matched data messages to be transmitted, and therefore, traffic load balance in the virtual local area network is achieved.

In an exemplary embodiment, the load balancing instruction may be generated for each target provider edge amongst the plurality of target provider edges by adopting, but not limited to the following ways: generating a target number of load balancing tokens, wherein the target number is the number of the plurality of target provider edges; and generating the load balancing instruction carrying the target number and the load balancing tokens, wherein the load balancing instruction is used for instructing each target provider edge to forward, according to message information carried by the received data messages to be transmitted, the target number and the load balancing tokens, target data messages matched with the load balancing tokens amongst the data messages to be transmitted.

Alternatively, in this embodiment, it may be, but not limited to that the number of the target provider edges is determined as the target number.

Alternatively, in this embodiment, the load balancing tokens may be determined according to, but not limited to the number of the target provider edges, for example, with three target provider edges as an example, the load balancing tokens of the target provider edges may include, but not limited to 0, 1 and 2.

Alternatively, in this embodiment, the above-mentioned load balancing instruction may include, but not limited to information used for instructing the number of the target provider edges and the load balancing tokens of the target provider edges, and the load balancing instruction may be, but not limited to, used for instructing, according to the number of the target provider edges and the load balancing tokens, the target provider edges to be matched with the corresponding message information carried in the data messages to be transmitted.

Alternatively, in this embodiment, the data messages to be transmitted may include, but not limited to BUM data in the same virtual local area network (i.e., VLAN) in the Ethernet virtual private network configured in a network.

Alternatively, in this embodiment, the data messages to be transmitted may be, but not limited to data messages carrying the message information, and each target data message matched with each provider edge may be determined according to, but not limited to the target number and the load balancing tokens carried in the load balancing instruction, for example, with the data message A to be transmitted carrying message information A, the data message B to be transmitted carrying message information B, the data message C to be transmitted carrying message information C, the load balancing instruction instructing the target number, and the target provider edges including a target PE1 in which the number of the load balancing tokens is 0, a target PE2 in which the number of the load balancing tokens is 1 and a target PE3 in which the number of the load balancing tokens is 2 as an example, a target provider edge matched with the data message A to be transmitted may be determined, according to, but not limited to the message information A carried in the data message A to be transmitted and the target number, as the target PE1 in which the number of the load balancing tokens is 0, a target provider edge matched with the data message B to be transmitted is determined, according to the message information B carried in the data message B to be transmitted and the target number, as the target PE2 in which the number of the load balancing tokens is 1, and a target provider edge matched with the data message C to be transmitted is determined, according to the message information C carried in the data message C to be transmitted and the target number, as the target PE3 in which the number of the load balancing tokens is 2.

In an exemplary embodiment, THE target number of load balancing tokens may be generated by adopting, but not limited to the following ways: determining the number of the plurality of target provider edges to obtain the target number M; and generating a natural number ranging from 0 to M-1 as the target number of the load balancing tokens.

Alternatively, in this embodiment, it may be, but not limited to that the number of all the provider edges is determined as the target number M, and M may be, but not limited to a natural number.

Alternatively, in this embodiment, the number of the load balancing tokens may be, but not limited to be a natural number generated according to the target number and ranging from 0 to a number smaller than the target number by 1, for example, with the target number being 3(M=3) as an example, it may be, but not limited to that 0 , 1, 2 (0 to M-1) load balancing tokens are generated.

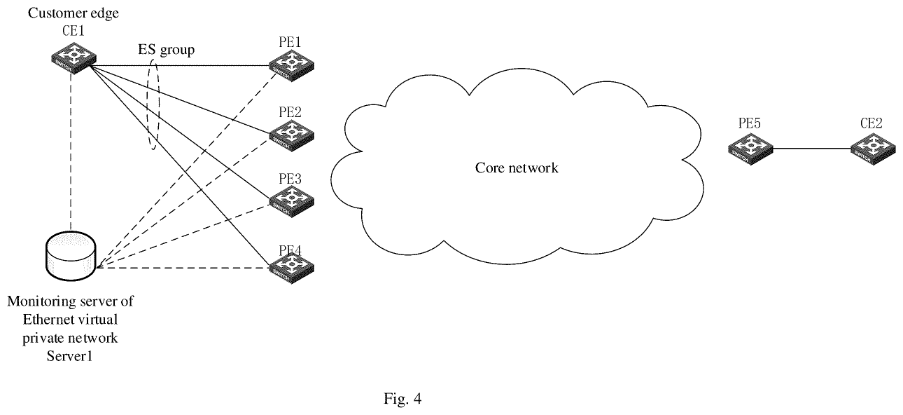

In an exemplary embodiment, provided is an example of issuing load balancing tokens. FIG. 3 is a process diagram of issuing load balancing tokens according to an embodiment, as shown in FIG. 3, the load balancing tokens may be issued to the target provider edges by adopting, but not limited to the following ways:

S302: receiving the network parameters (i.e., link state information) reported by each candidate provider edge by the monitoring server of the Ethernet virtual private network, wherein the network parameters may be, but not limited to be reported by the candidate provider edges within the target period based on the mirrored messages;

S304: determining the number of the candidate provider edges connected to the same customer edge;

S306: calculating the link parameter ΣJ of each candidate provider edge according to the network parameters;

S308: comparing the link parameter ΣJ of each candidate provider edge with the parameter threshold (i.e., an average critical routing parameter) defined according to a network condition;

S310: determining candidate provider edges with link parameters being smaller than or equal to the parameter threshold as target provider edges (i.e., load sharing provider edge node group members) with connecting links being in a normal link state;

S312: issuing the load balancing tokens to each target provider edge;

S314: for candidate provider edges with link parameters being greater than the parameter threshold (i.e., an average critical routing parameter), regarding that the connecting links of the candidate provider edges are in an abnormal link state; and

S316: not issuing the load balancing tokens to the candidate provider edges with the connecting links being in the abnormal link state.

In the technical solution provided in above-mentioned step S206, each target provider edge may be instructed by using, but not limited to the load balancing instruction to forward the target data messages, matched with the target provider edges, from the data messages to be transmitted to the customer edge. For example, under the condition that each target provider edge receives the load balancing instruction, the load balancing tokens and the target number that are indicated in the load balancing instruction are acquired, the matched target data messages are determined from the data messages to be transmitted according to the load balancing tokens and the target number, and the target data messages are forwarded to the customer edge.

In an exemplary embodiment, the load balancing instructions may be issued to the corresponding target provider edges by adopting, but not limited to the following ways: packaging the load balancing instructions as signaling messages; and issuing the signaling messages to the corresponding target provider edges.

Alternatively, in this embodiment, the above-mentioned signaling messages are used for issuing an instruction from the monitoring server of the Ethernet virtual private network to the provider edges, that is, the load balancing instructions may be issued to the corresponding target provider edges by using, but not limited to the signaling messages, and are used for instructing the target provider edges to determine matched target data messages from the data messages to be transmitted.

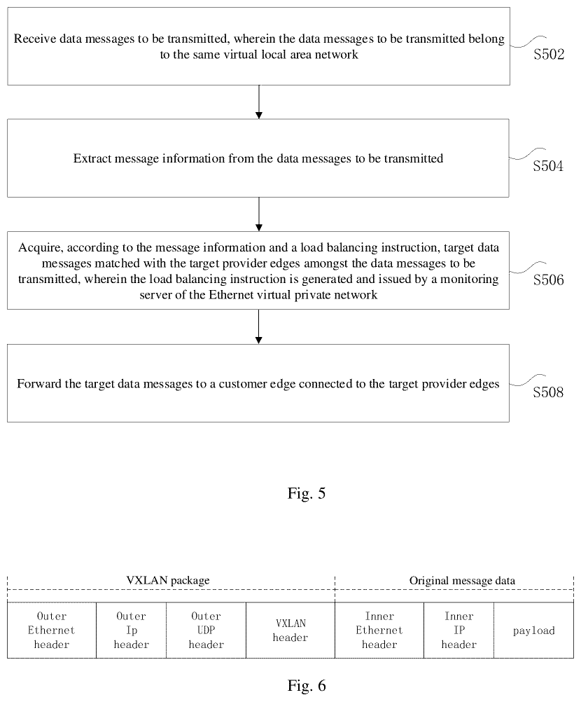

In an exemplary embodiment, provided is an example of load balancing transmission of data messages. FIG. 4 is a first process diagram of load-balanced data message transmission according to an embodiment, as shown in FIG. 4, with a CE1 and provider edges (which may include, but are not limited to a PE1, a PE2, a PE3 and a PE4) being configured with the same monitoring server (i.e., a Server 1) of the Ethernet virtual private network as an example, the provider edges also establish a BGP neighborhood relationship with a Server1 while establishing a BGP neighborhood relationship thereamong, and the provider edges and the monitoring server are defined to include message data of start messages (used for the provider edges to report their Ethernet network segment numbers and other information to the Server 1), mirrored messages (used for reporting the network parameters, collected by the provider edges, of the connecting link between each provider edge and the CE1 to the Server1) and signaling messages (used for issuing an instruction from the Server1 to the provider edges), and it may be, but not limited to that the start messages, the mirrored messages and the signaling messages are packaged into a BGP update message for transmission;
the monitoring server receives, based on the start messages, the Ethernet network segment number reported by each provider edge, and determines, according to the Ethernet network segment numbers reported by the provider edges, that the provider edges having the same Ethernet network segment number are connected to the same customer edge to obtain the candidate provider edges (it may be, but not limited to that the candidate provider edges connected to the same customer edge are determined as one ES group);
the monitoring server receives the network parameters reported by each candidate provider edge based on the mirrored message and according to the target period and including the bandwidth utilization rate k1, the latency k2, the jitter k3 and the packet loss rate k4, determines weights p of the network parameters (which may include, but are not limited to the weight p1 of the bandwidth utilization rate, the weight p2 of the latency, the weight p3 of the jitter and the weight p4 of the packet loss rate) according to the degree of impact of each network parameter on the network state, and performs weighted average calculation on all the network parameters to obtain the link parameter of the connecting link, i.e., ΣJ=(k1p1+k2p2+k3p3+k4p4)*100%;
the monitoring server receives the link parameter of the connecting link between each candidate provider edge and the same customer edge, and determines the provider edges with link parameters being smaller than or equal to the parameter threshold defined according to the network condition as the target provider edges with the connecting links being in the normal link state; and
according to the number of the target provider edges, 0 to 1 serving as the number of the target provider edges is generated as the target number of the load balancing tokens, each target provider edge is instructed by the target number and the load balancing tokens to forward, according to the message information carried by the received data messages to be transmitted, the target number and the load balancing tokens, the target data messages matched with the load balancing tokens amongst the data messages to be transmitted.

It may be, but not limited to that the link parameters of the candidate provider edges are calculated by setting the weight pl of the bandwidth utilization rate=the weight p2 of the latency the weight p3 of the jitter the weight p4 of the packet loss rate. For example, with a first candidate provider edge having the bandwidth utilization rate k1=20%, the latency k2=30 ms, the jitter k3=40 ms, and the packet loss rate k4=0.1 as an example, it is calculated that the link parameter ΣJ(PE1) of the first candidate provider edge={the bandwidth utilization rate (20%)*25%+the latency (30 ms)*25%+the jitter (40ms)*25%+the packet loss rate(0.1)*25%}={0.2*0.25+30*0.25+40*0.25+0.1*0.25}*100%=1757.5; and
with the link parameters of the candidate provider edges (which may include, but not limited to PE1, PE2, PE3 and PE4) being respectively ΣJ(PE1)=1757.5, ΣJ(PE2)=1701, ΣJ(PE3)=1780, and ΣJ(PE4)=1860, and the parameter threshold defined according to a network condition being 1800 as an example, since the link parameters ΣJ(PE1), ΣJ(PE2) and ΣJ(PE3) are smaller than the parameter threshold, it is regarded that link stages from the candidate PE1, the candidate PE2 and the candidate PE3 to the CE1 are normal, which satisfies a data forwarding demand, whereby the candidate PE1, the candidate PE2 and the candidate PE3 may be determined as the target provider edges; and ΣJ(PE4) is greater than 1800, which indicates that a link state from the PE4 to the CE1 is abnormal, which cannot satisfy the data forwarding demand, and therefore, the number of the target provider edges is 3, it may be, but not limited to that the number of the tokens of the PE1 is determined as 0, the number of the tokens of the PE2 is determined as 1, the number of the tokens of the PE3 is determined as 2, and the PE4 does not obtain the tokens.

The monitoring server may package, but not limited to package the tokens corresponding to the target provider edges (which may include, but not limited to the target PE1, the target PE2 and the target PE3) as the signaling messages to be issued to the corresponding target provider edges.

The CE2 is only connected to the PE5, and therefore, the message data is forwarded to the CE2 by using the PE5.

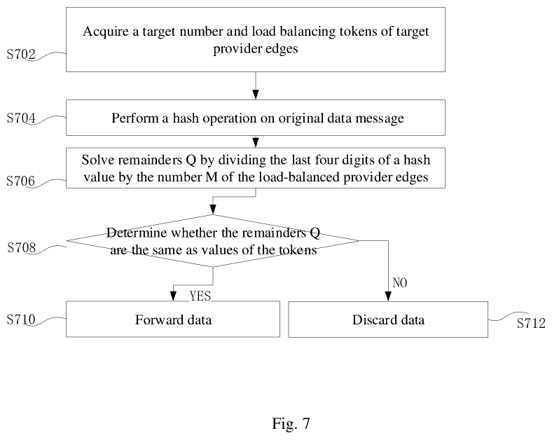

This embodiment provides a data message transmission control method applied to target provider edges in an Ethernet virtual private network, FIG. 5 is a second process diagram of data message transmission control according to an embodiment of the present application, as shown in FIG. 2, the process includes the following steps:
step S502, receiving data messages to be transmitted, wherein the data messages to be transmitted belong to the same virtual local area network;
step S504, extracting message information from the data messages to be transmitted;
step S506, acquiring, according to the message information and a load balancing instruction, target data messages matched with the target provider edges amongst the data messages to be transmitted, wherein the load balancing instruction is generated and issued by a monitoring server of the Ethernet virtual private network; and
step S508, forwarding the target data messages to a customer edge connected to the target provider edges.

According to the above-mentioned steps, the plurality of target provider edges connected to the same customer edge are used as devices allowing to forward data messages in the same virtual local area network. The load balancing instruction is generated for each target provider edge, wherein the load balancing instruction instructs each target provider edge to forward, according to the message information carried by the received data messages to be transmitted and the load balancing instruction, a target data message matched with each target provider edge, whereby the data messages in the same virtual local area network might be distributed to the different target provider edges for forwarding, and load balancing of the data messages in the same virtual local area network is achieved. Therefore, the problem of relatively low transmission efficiency of data messages might be solved, and the effect of improving the transmission efficiency of the data messages might be achieved.

The above-mentioned steps may be, but not limited to, applied to the target provider edges in the Ethernet virtual private network.

In the technical solution provided in above-mentioned step S502, the above-mentioned data messages to be transmitted may include, but not limited to BUM data in the same virtual local area network (i.e., a VLAN) in the Ethernet virtual private network configured in a network.

In the technical solution provided in above-mentioned step S504, the above-mentioned data messages to be transmitted may include, but not limited to a plurality of data segments, and the message information may be obtained by extracting, but not limited to extract the target data segments in the data messages to be transmitted, whereby the message information is extracted from the data messages to be transmitted.
In an exemplary embodiment, the message information may be extracted from the data messages to be transmitted by adopting, but not limited to the following ways: extracting original message data following a VXLAN header field from the data messages to be transmitted; and performing a hash operation on the original message data to obtain the message information.

Alternatively, in this embodiment, the above-mentioned data messages to be transmitted may include, but not limited to a plurality of fields, and the original message data may be determined by extracting, but not limited to extract fields following the VXLAN header field.

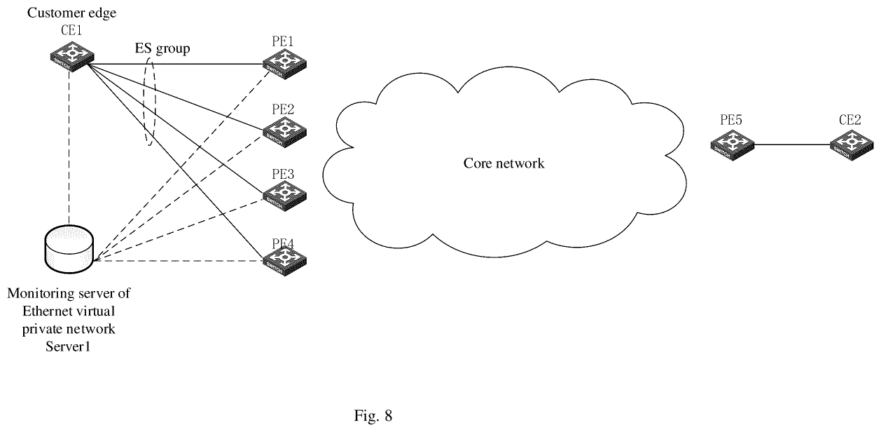

In an exemplary embodiment, provided is an example of a traditional VXLAN message. FIG. 6 is a schematic diagram of a traditional VXLAN message according to an embodiment, as shown in FIG. 6, it may be, but not limited to that a format of the traditional VXLAN message (i.e., the data messages to be transmitted) is not changed, the format of the traditional VXLAN message may include, but not limited to a VXLAN package, wherein the VXLAN package may include, but not limited to an Outer Ethernet header (used for bearing an Ethernet header of a VXLAN packet), an Outer Ip header (used for bearing an IP data header of an entire data packet), an Outer UDP header (used for bearing a UDP data header of the entire data packet), a VXLAN header (used for identifying a header of VXLAN package data) and original message data; and the original message data in the VXLAN package may include, but not limited to an Inner Ethernet header, and Inner IP header and a payload.

The hash operation may be performed on the original message data following the VXLAN header field by using, but not limited to the VXLAN header (i.e., the VXLAN header package) in the VXLAN message as a boundary to obtain the message information.

In the technical solution provided in above-mentioned step S506, the above-mentioned load balancing instruction may be, but not limited to be used by the monitoring server of the Ethernet virtual private network to instruct the target provider edges to be matched with the target data messages from the data messages to be transmitted. When the target provider edges receive the load balancing instruction, the target data messages may be matched from all the received data messages to be transmitted according to, but not limited to the load balancing instruction and the message information.

In an exemplary embodiment, the target data messages matched with the target provider edges amongst the data messages to be transmitted may be acquired according to the message information and the load balancing instruction by adopting, but not limited to the following ways: determining message identifiers according to the message information and the target number carried in the load balancing instruction, wherein the target number is the number of the plurality of target provider edges screened by the monitoring server and used for forwarding the data messages to be transmitted; matching the message identifiers with the load balancing tokens carried in the load balancing instruction; and determining the data messages to be transmitted as the target data messages under the condition that the message identifiers are successfully matched with the load balancing tokens.

Alternatively, in this embodiment, the above-mentioned target number may be, but not limited to the number of target provider edges forming a good link state with the customer edge amongst the provider edges connected to the same customer edge. For example, the provider edges include a PE1, a PE2 and a PE3, and the PE1, the PE2 and the PE3 are connected to the same customer edge. However, the PE2 and the PE3 are in a good link state, and therefore, the number of the target provider edges is 2 (it may be, but not limited to that the PE2 and the PE3 are included).

Alternatively, in this embodiment, the message identifiers may be obtained according to, but not limited to the number of the target provider edges and the message information, and may be, but not limited to be used to be matched with the load balancing tokens obtained by the target provider edges, whereby the target data messages matched with the target provider edges are determined from all the data messages to be transmitted.

Alternatively, in this embodiment, the target data messages corresponding to the target provider edges may be determined according to, but not limited to a result that the message identifiers are matched with the load balancing tokens of the target provider edges. For example, the data messages to be transmitted and corresponding to the message identifiers are determined as the target data messages of the target provider edges under the condition that the message identifiers are matched with the load balancing instructions of the target provider edges.

In an exemplary embodiment, the message identifiers may be determined according to the message information and the target number carried in the load balancing instruction by adopting, but not limited to the following ways: calculating remainders obtained by dividing the message information by the target number as the message identifiers, wherein the message identifiers are obtained by performing the hash operation on the original message data in the data messages to be transmitted; and the message identifiers may be matched with the load balancing tokens carried in the load balancing instruction by adopting, but not limited to the following ways: comparing the remainders with the load balancing tokens, wherein the number of the load balancing tokens is a natural number ranging from 0 to M-1 generated by the monitoring server, and M is the target number; and determining, under the condition that the remainders are consistent with the load balancing tokens by comparison, that the message identifiers are successfully matched with the load balancing tokens.

Alternatively, in this embodiment, the message information of the original message data may be obtained by performing, but not limited to performing the hash operation on the original message data in the data messages to be transmitted. It may be, but not limited to that the remainders calculated by dividing the message information by the number of the target provider edges are used as the message identifiers.

Alternatively, in this embodiment, it may be determined whether the message identifiers are matched with the load balancing tokens by adopting, but not limited to the following ways, for example, the message identifiers are matched with the load balancing tokens carried in the load balancing instruction, and under the condition that the message identifiers are equal to the load balancing tokens, it may be, but not limited to, regarded that the message identifiers are matched with the load balancing tokens. Or, under the condition that a matching rule is predetermined, the message identifiers are in one-to-one correspondence with the load balancing tokens according to the matching rule, it may be, but not limited to be regarded that the message identifiers are matched with the load balancing tokens.

In an exemplary embodiment, after the message identifiers are matched with the load balancing tokens carried in the load balancing instruction, the data messages to be transmitted may be processed by adopting, but not limited to the following ways: discarding the data messages to be transmitted under the condition that the message identifiers fail to be matched with the load balancing tokens.

Alternatively, in this embodiment, it may be determined whether the message identifiers are matched with the load balancing tokens by adopting, but not limited to the following ways, for example, the message identifiers are matched with the load balancing tokens carried in the load balancing instruction, and under the condition that the message identifiers are not equal to the load balancing tokens, it may be, but not limited to, regarded that the message identifiers are not matched with the load balancing tokens, and the target provider edges discard the data messages to be transmitted and corresponding to the message identifiers. Or, under the condition that the matching rule is predetermined, the message identifiers are not in one-to-one correspondence with the load balancing tokens according to the matching rule, it may be, but not limited to be regarded that the message identifiers are not matched with the load balancing tokens, and the target provider edges discard the data messages to be transmitted and corresponding to the message identifiers.

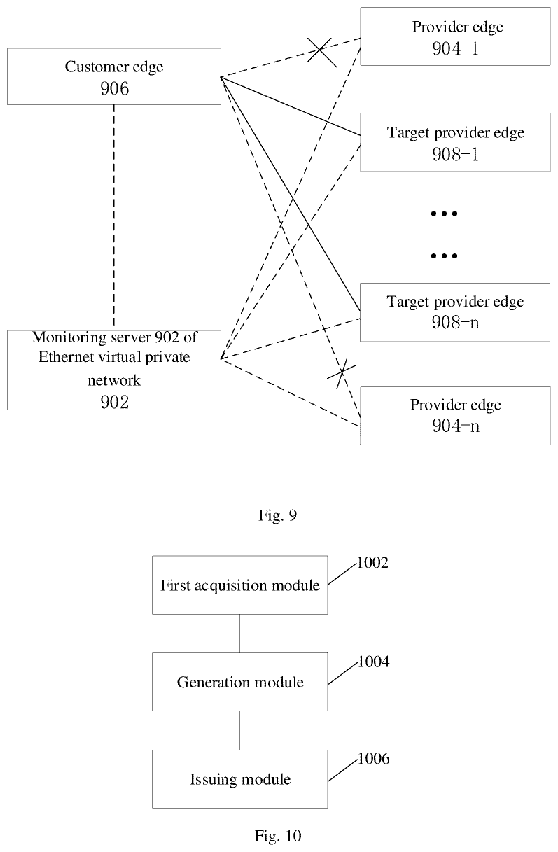

In an exemplary embodiment, provided is an example of determining target data messages of target provider edges. FIG. 7 is a process diagram of determining target data messages of target provider edges according to an embodiment, as shown in FIG. 7, the target data messages of the target provider edges may be determined by using, but not limited to the following steps:

S702: acquiring a target number and load balancing tokens of target provider edges;

S704: extracting original message data following a VXLAN header field from data messages to be transmitted, and then, performing a hash operation on the original data message to obtain message information (which may be, but not limited to the last four digits of an obtained Hash value);

S706: determining remainders Q obtained by dividing the message information by the target number (the number M of load-balanced PEs) as message identifiers;

S708: using the message identifiers to be matched with the load balancing tokens of the target provider edges;

S710: forwarding target data messages corresponding to the message identifiers by using the target provider edges corresponding to the load balancing tokens under an optional condition that the message identifiers are equal to the load balancing tokens; and

S712: discarding, by provider edges, data messages corresponding to the message identifiers under an optional condition that the message identifiers are not equal to the load balancing tokens or the provider edges do not receive the load balancing tokens.

In an exemplary embodiment, before the target data messages matched with the target provider edges amongst the data messages to be transmitted are acquired according to the message information and the load balancing instruction, the network parameters may be reported by adopting, but not limited to the following ways: reporting network parameters to the monitoring server based on a mirrored message, wherein the network parameters include at least one of following parameters: a bandwidth utilization rate, a latency, a jitter and a packet loss rate; and receiving the load balancing instruction issued by the monitoring server in response to the network parameters and based on a signaling message.

Alternatively, in this embodiment, the above-mentioned mirrored message may be, but not limited to be defined between a provider edge and the monitoring server. The mirrored message may be, but not limited to be used for reporting the network parameters, collected by the provider edge, of the connecting link between the provider edge and the customer edge.

Alternatively, in this embodiment, the above-mentioned signaling message is used for issuing an instruction from the monitoring server to the provider edge, that is, the load balancing instructions may be issued to the corresponding target provider edges by using, but not limited to the signaling message which instructs the target provider edges to determine the matched target data messages from the data messages to be transmitted.

In an exemplary embodiment, the network parameters may be reported to the monitoring server based on the mirrored message by adopting, but not limited to the following ways: reporting the network parameters based on the mirrored message and according to a target period; receiving a reporting instruction sent by the monitoring server; and making a response to the reporting instruction to report the network parameters based on the mirrored message.

Alternatively, in this embodiment, the above-mentioned mirrored message may be, but not limited to be sampled at one time within a certain period, the sampling period may be, but not limited to be adjustable.

Alternatively, in this embodiment, the above-mentioned target period is used for instructing a time interval of two adjacent times when the candidate provider edges report the network parameters collected based on the mirrored message to the monitoring server, and the target period may be, but not limited to be adjustable, for example, the network parameters are reported to the monitoring server based on the mirrored message every other 300 s. Or, the network parameters are reported to the monitoring server based on the mirrored message every other 400 s.

In an exemplary embodiment, before the target data messages matched with the target provider edges amongst the data messages to be transmitted are acquired according to the message information and the load balancing instruction, an Ethernet network segment number may be reported by adopting, but not limited to the following ways: establishing communication connection with the monitoring server; and reporting an Ethernet network segment number to the monitoring server based on a start message.

Alternatively, in this embodiment, the communication connection between each provider edge and the monitoring server may be established by adopting, but not limited to the following ways. For example, with the Ethernet virtual private network being configured in the network as an example, the customer edge and the provider edges are configured with the same monitoring server, the provider edges also establish a BGP neighborhood relationship (i.e., communication connection) with the monitoring server while establishing a BGP neighborhood relationship there among, and the provider edges and the monitoring server may be, but not limited to be defined to include message data of start messages (used for the provider edges to report their Ethernet network segment numbers and other information to the monitoring server), mirrored messages (used for reporting the network parameters, collected by the provider edges, of the connecting link between each provider edge and the customer edge to the monitoring server) and signaling messages (used for issuing an instruction from the monitoring server to the provider edges), and it may be, but not limited to that the start messages, the mirrored messages and the signaling messages are packaged into a BGP update (message information in an update format) message for transmission.

Alternatively, in this embodiment, the above-mentioned start messages are used for the provider edges to report their Ethernet network segment numbers and other information to the monitoring server. The start messages may be, but not limited to first message data sent after a Transmission Control Protocol (TCP) connection is established between each provider edge and the monitoring server, and the start messages are used for identifying the provider edges having the same Ethernet network segment number as the same redundant backup group.

In the technical solution provided in above-mentioned step S508, the target provider edges may forward the target data messages to, but not limited to the customer edge connected to the target provider edges under the condition that the target data messages matched with the target provider edges are determined.

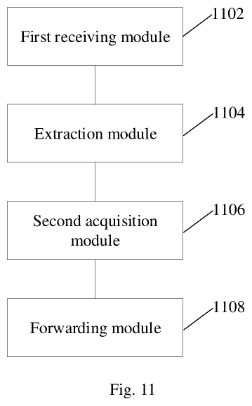

In an exemplary embodiment, provided is an example of load-balanced data message transmission. FIG. 8 is a second process diagram of load-balanced data message transmission according to an embodiment. As shown in FIG. 8, with a CE1 and provider edges (which may include, but not limited to a PE1, a PE2, a PE3 and a PE4) being configured with the same monitoring server (which may be, but not limited to Server1) as an example, when all of the target PE1 having a load balancing token 0, the target PE3 having a load balancing token 1, the target PE3 having a load balancing token 2 and the PE4 obtaining no load balancing tokens receive data messages to be transmitted in the same virtual local area network (it may be, but not limited to that the PE1, the PE2, the PE3 and the PE4 are determined as an ES group), each provider edge extracts original message data following a VXLAN header field from the data messages to be transmitted to perform a hash operation to obtain message information, and the message information obtained by performing the hash operation according to the target number 3 and the original message data may include, but not limited to 9000, 9001, 9002, 9003, 9004 and 9005 respectively;
the target PE1 is matched, according to the target number 3, with the load balancing token 0 carried in the load balancing instruction, the message information 9000 is divided by 3 to obtain a remainder 0 (i.e., a message identifier) which is matched with the load balancing token 0, the message information 9003 is divided by 3 to obtain a remainder 0 (i.e., the message identifier) which is matched with the load balancing token 0, and therefore, the target PE1 may be used to forward target data messages of the message information 9000 and the message information 9003 to the CE1, and discharge data messages of the message information 9001, the message information 9002, the message information 9003, the message information 9004 and the message information 9005;
the target PE2 is matched, according to the target number 3, with the load balancing token 1 carried in the load balancing instruction, the message information 9001 is divided by 3 to obtain a remainder 1 (i.e., a message identifier) which is matched with the load balancing token 1, the message information 9004 is divided by 3 to obtain a remainder 1 (i.e., the message identifier) which is matched with the load balancing token 1, and therefore, the target PE2 may be used to forward target data messages of the message information 9001 and the message information 9004 to the CE1, and discharge the remaining data messages;

the target PE3 is matched, according to the target number 3, with the load balancing token 2 carried in the load balancing instruction, the message information 9002 is divided by 3 to obtain a remainder 2 (i.e., a message identifier) which is matched with the load balancing token 2, the message information 9005 is divided by 3 to obtain a remainder 2 (i.e., the message identifier) which is matched with the load balancing token 2, and therefore, the target PE3 may be used to forward target data messages of the message information 9002 and the message information 9005 to the CE1, and discharge the remaining data messages; and
the target PE4 obtains no load balancing tokens, and therefore, the PE4 cannot forward the data messages.

A CE2 is only connected to a PE5 and is not configured with the Server1, and therefore, the PE5 cannot be used to forward message data in a VLAN in the Server1.

Based on the description in above implementation, it might be clearly known by the skilled in the art that the method according to the above-mentioned embodiment may be implemented by means of software and an essential general-purpose hardware platform, of course, it may also be implemented by hardware. However, the former is a better implementation in many cases. Based on such understanding, essences or parts, contributing to the prior art, of the technical solutions of the present application might be embodied in a form of a software product, and this computer software product is stored in a non-transitory readable storage medium (such as an ROM/RAM, a diskette and a compact disc), and includes a plurality of instructions, whereby the method in each embodiment of the present application is performed by one terminal device (which may be a mobile phone, a computer, a server, or a network device, etc.).

This embodiment further provides a data message transmission control system, FIG. 9 is a structural block diagram of a data message transmission control system according to an embodiment of the present application, as shown in FIG. 9, this system includes a monitoring server 902 of an Ethernet virtual private network and a plurality of provider edges (9041 to 904n),
the monitoring server 902 is respectively connected to a plurality of provider edges (9041 to 904n), and the plurality of provider edges (9041 to 904n) are connected to the same customer edge (906);
the monitoring server 902 is configured for acquiring a plurality of target provider edges (9081 to 908n) amongst the plurality of provider edges (9041 to 904n); generating a load balancing instruction for each target provider edge (9081 to 908n) amongst the plurality of target provider edges (9081 to 908n), wherein the load balancing instruction is used for instructing each target provider edge (9081 to 908n) to forward, according to message information carried by received data messages to be transmitted and the load balancing instruction, a target data message matched with each target provider edge (9081 to 908n) amongst the data messages to be transmitted, and the data messages to be transmitted belong to the same virtual local area network; and issuing the load balancing instructions to the corresponding target provider edges (9081 to 908n); and
the target provider edges (9081 to 908n) are configured for receiving the data messages to be transmitted, wherein the data messages to be transmitted belong to the same virtual local area network; extracting the message information from the data messages to be transmitted; acquiring, according to the message information and the load balancing instruction, the target data messages matched with the target provider edges (9081 to 908n) amongst the data messages to be transmitted; and forwarding the target data messages to the customer edge (906).

The monitoring server is further configured for acquiring all provider edges connected to the customer edge as candidate provider edges; and screening the plurality of target provider edges from the candidate provider edges according to a link state of each candidate provider edge, wherein the link state is a network state of a connecting link between each candidate provider edge and the customer edge.

The monitoring server is further configured for determining a link parameter corresponding to each candidate provider edge as the link state according to network parameters reported by each candidate provider edge, wherein the network parameters include at least one of following parameters: a bandwidth utilization rate, a latency, a jitter and a packet loss rate, and the smaller the link parameter is, the better the link state is; and screening corresponding provider edges with link parameters being smaller than or equal to a parameter threshold as the plurality of target provider edges from the candidate provider edges.

The monitoring server is further configured for receiving the network parameters reported by each candidate provider edge based on a mirrored message, wherein the network parameters include: the bandwidth utilization rate, the latency, the jitter and the packet loss rate; and calculating a weighted sum of the network parameters as the link parameter, wherein a weight of each network parameter is directly proportional to a degree of impact of each network parameter on the network state.

The monitoring server is further configured for receiving the network parameters reported by each candidate provider edge based on the mirrored message and according to a target period; sending a reporting instruction to each candidate provider edge; and receiving the network parameters reported by each candidate provider edge in response to the reporting instruction and based on the mirrored message.

The monitoring server is further configured for receiving an Ethernet network segment number reported, based on a start message, by each provider edge that has established communication connection; and determining provider edges having the same Ethernet network segment number as all the provider edges connected to the same customer edge to obtain the candidate provider edges.

The monitoring server is further configured for generating a target number of load balancing tokens, wherein the target number is the number of the plurality of target provider edges; and generating the load balancing instruction carrying the target number and the load balancing tokens, wherein the load balancing instruction is used for instructing each target provider edge to forward, according to message information carried by received data messages to be transmitted, the target number and the load balancing tokens, target data messages matched with the load balancing tokens amongst the data messages to be transmitted.

The monitoring server is further configured for determining the number of the plurality of target PEs to obtain the target number M; and generating a natural number ranging from 0 to M-1 as the target number of the load balancing tokens.

The monitoring server is further configured for packaging the load balancing instructions as signaling messages; and issuing the signaling messages to the corresponding target provider edges.

The target provider edges are further configured for receiving data messages to be transmitted, wherein the data messages to be transmitted belong to the same virtual local area network; extracting message information from the data messages to be transmitted; acquiring, according to the message information and a load balancing instruction, target data messages matched with the target provider edges amongst the data messages to be transmitted, wherein the load balancing instruction is generated and issued by a monitoring server of the Ethernet virtual private network; and forwarding the target data messages to a customer edge connected to the target provider edges.

The target provider edges are further configured for determining message identifiers according to the message information and the target number carried in the load balancing instruction, wherein the target number is the number of the plurality of target provider edges screened by the monitoring server and used for forwarding the data messages to be transmitted; matching the message identifiers with the load balancing tokens carried in the load balancing instruction; and determining the data messages to be transmitted as the target data messages under the condition that the message identifiers are successfully matched with the load balancing tokens.

The target provider edges are further configured for determining message identifiers according to the message information and a target number carried in the load balancing instruction, which includes: calculating remainders obtained by dividing the message information by the target number as the message identifiers, wherein the message information is obtained by performing a hash operation on original message data in the data messages to be transmitted; and matching the message identifiers with load balancing tokens carried in the load balancing instruction, which includes: comparing the remainders with the load balancing tokens, wherein the number of the load balancing tokens is a natural number ranging from 0 to M-1 generated by the monitoring server, and M is the target number; and determining, under the condition that the remainders are consistent with the load balancing tokens by comparison, that the message identifiers are successfully matched with the load balancing tokens.

The target provider edges are further configured for discarding the data messages to be transmitted under the condition that the message identifiers fail to be matched with the load balancing tokens.

The target provider edges are further configured for reporting network parameters to the monitoring server based on a mirrored message, wherein the network parameters include at least one of following parameters: a bandwidth utilization rate, a latency, a jitter and a packet loss rate; and receiving the load balancing instruction issued by the monitoring server in response to the network parameters and based on a signaling message.

The target provider edges are further configured for reporting the network parameters based on the mirrored message and according to a target period; receiving a reporting instruction sent by the monitoring server; and making a response to the reporting instruction to report the network parameters based on the mirrored message. The target provider edges are further configured for establishing communication connection with the monitoring server; and reporting an Ethernet network segment number to the monitoring server based on a start message.

The target provider edges are further configured for extracting original message data following a VXLAN header field from the data messages to be transmitted; and performing the hash operation on the original message data to obtain the message information.

This embodiment further provides a data message transmission control apparatus which is configured for implementing the above-mentioned embodiments and optional implementations, among which the completed description will no longer be repeated. As used below, the term “module” might be used to achieve a combination of software and/or hardware having predetermined functions. Although an apparatus described in the following embodiment is in some embodiments implemented in a form of software, hardware or a combination of the software and the hardware may also be implemented or conceived.

FIG. 10 is a structural block diagram of a data message transmission control apparatus applied to an Ethernet virtual private network according to an embodiment of the present application, as shown in FIG. 10, the apparatus includes:
a first acquisition module 1002 configured for acquiring a plurality of target provider edges connected to the same customer edge;
a generation module 1004 configured for generating a load balancing instruction for each target provider edge amongst the plurality of target provider edges, wherein the load balancing instruction is used for instructing each target provider edge to forward, according to message information carried by received data messages to be transmitted and the load balancing instruction, a target data message matched with each target provider edge amongst the data messages to be transmitted, and the data messages to be transmitted belong to the same virtual local area network; and
an issuing module 1006 configured for issuing the load balancing instructions to the corresponding target provider edges, wherein the target provider edges are configured for forwarding the target data messages to the customer edge by using the received load balancing instructions.

According to the above-mentioned apparatus, the plurality of target provider edges connected to the same customer edge are used as devices allowing to forward data messages in the same virtual local area network. The load balancing instruction is generated for each target provider edge, wherein the load balancing instruction instructs each target provider edge to forward, according to the message information carried by the received data messages to be transmitted and the load balancing instruction, a target data message matched with each target provider edge, whereby the data messages in the same virtual local area network might be distributed to the different target provider edges for forwarding, and load balancing of the data messages in the same virtual local area network is achieved. Therefore, the problem of relatively low transmission efficiency of data messages might be solved, and the effect of improving the transmission efficiency of the data messages might be achieved.

In an exemplary embodiment, the first acquisition module includes:
an acquisition unit configured for acquiring all provider edges connected to the customer edge as candidate provider edges; and
a screening unit configured for screening the plurality of target provider edges from the candidate provider edges according to a link state of each candidate provider edge, wherein the link state is a network state of a connecting link between each candidate provider edge and the customer edge.

In an exemplary embodiment, the screening unit is configured for determining a link parameter corresponding to each candidate provider edge as the link state according to network parameters reported by each candidate provider edge, wherein the network parameters include at least one of following parameters: a bandwidth utilization rate, a latency, a jitter and a packet loss rate, and the smaller the link parameter is, the better the link state is; and screening corresponding provider edges with link parameters being smaller than or equal to a parameter threshold as the plurality of target provider edges from the candidate provider edges.

In an exemplary embodiment, the screening unit is further configured for receiving the network parameters reported by each candidate provider edge based on a mirrored message, wherein the network parameters include: the bandwidth utilization rate, the latency, the jitter and the packet loss rate; and calculating a weighted sum of the network parameters as the link parameter, wherein a weight of each network parameter is directly proportional to a degree of impact of each network parameter on the network state.

In an exemplary embodiment, the screening unit is further configured for receiving the network parameters reported by each candidate provider edge based on the mirrored message and according to a target period; sending a reporting instruction to each candidate provider edge; and receiving the network parameters reported by each candidate provider edge in response to the reporting instruction and based on the mirrored message.

In an exemplary embodiment, the acquisition unit is further configured for receiving an Ethernet network segment number reported, based on a start message, by each provider edge that has established communication connection; and determining provider edges having the same Ethernet network segment number as all the provider edges connected to the same customer edge to obtain the candidate provider edges.

In an exemplary embodiment, the generation module includes:
a first generation unit configured for generating a target number of load balancing tokens, wherein the target number is the number of the plurality of target provider edges; and
a second generation unit configured for generating the load balancing instruction carrying the target number and the load balancing tokens, wherein the load balancing instruction is used for instructing each target provider edge to forward, according to message information carried by received data messages to be transmitted, the target number and the load balancing tokens, target data messages matched with the load balancing tokens amongst the data messages to be transmitted.

In an exemplary embodiment, the first generation unit is configured for determining the number of the plurality of target provider edges to obtain the target number M; and generating a natural number ranging from 0 to M-1 as the target number of the load balancing tokens.

In an exemplary embodiment, the issuing module includes:
a packaging unit configured for packaging the load balancing instructions as signaling messages; and
an issuing unit configured for issuing the signaling messages to the corresponding target provider edges.

FIG. 11 is a structural block diagram of a data message transmission control apparatus applied to target provider edges according to an embodiment of the present application, as shown in FIG. 11, the apparatus includes:
a first receiving module 1102 configured for receiving data messages to be transmitted, wherein the data messages to be transmitted belong to the same virtual local area network;
an extraction module 1104 configured for extracting message information from the data messages to be transmitted;
a second acquisition module 1106 configured for acquiring, according to the message information and a load balancing instruction, target data messages matched with the target provider edges amongst the data messages to be transmitted, wherein the load balancing instruction is generated and issued by a monitoring server of the Ethernet virtual private network; and
a forwarding module 1108 configured for forwarding the target data messages to a customer edge connected to the target provider edges.

In an exemplary embodiment, the second acquisition module includes:
a first determination unit configured for determining message identifiers according to the message information and a target number carried in the load balancing instruction, wherein the target number is the number of the plurality of target provider edges screened by the monitoring server and used for forwarding the data messages to be transmitted;
a matching unit configured for matching the message identifiers with load balancing tokens carried in the load balancing instruction; and
a second determination unit configured for determining the data messages to be transmitted as the target data messages under the condition that the message identifiers are successfully matched with the load balancing tokens.

In an exemplary embodiment, the first determination unit is configured for determining message identifiers according to the message information and a target number carried in the load balancing instruction, which includes: calculating remainders obtained by dividing the message information by the target number as the message identifiers, wherein the message information is obtained by performing a hash operation on original message data in the data messages to be transmitted.

In an exemplary embodiment, the matching unit is configured for matching the message identifiers with load balancing tokens carried in the load balancing instruction, which includes: comparing the remainders with the load balancing tokens, wherein the number of the load balancing tokens is a natural number ranging from 0 to M-1 generated by the monitoring server, and M is the target number; and determining, under the condition that the remainders are consistent with the load balancing tokens by comparison, that the message identifiers are successfully matched with the load balancing tokens.

In an exemplary embodiment, the apparatus further includes:
a discarding module configured for discarding the data messages to be transmitted under the condition that the message identifiers fail to be matched with the load balancing tokens.

In an exemplary embodiment, the apparatus further includes:
a first reporting module configured for reporting network parameters to the monitoring server based on a mirrored message, wherein the network parameters include at least one of following parameters: a bandwidth utilization rate, a latency, a jitter and a packet loss rate; and
a second receiving module configured for receiving the load balancing instruction issued by the monitoring server in response to the network parameters and based on a signaling message.

In an exemplary embodiment, the first reporting module includes one of the following units:
a reporting unit configured for reporting the network parameters based on the mirrored message and according to a target period;
a receiving unit configured for receiving a reporting instruction sent by the monitoring server; and
a response unit configured for making a response to the reporting instruction to report the network parameters based on the mirrored message.

In an exemplary embodiment, the apparatus further includes:
an establishing module configured for establishing communication connection with the monitoring server; and
a second reporting module configured for reporting an Ethernet network segment number to the monitoring server based on a start message.

In an exemplary embodiment, the extraction module includes:
an extraction unit configured for extracting original message data following a VXLAN header field from the data messages to be transmitted; and
an operation unit configured for performing the hash operation on the original message data to obtain the message information.

It should be noted that each of the above-mentioned modules might be implemented by software or hardware, and the hardware may be implemented by adopting, but not limited to the following ways: the above-mentioned modules are all located in the same processor; or the above-mentioned modules are respectively located in different processors in a form of any combination.

An embodiment of the present application further provides a computer non-transitory readable storage medium, the computer non-transitory readable storage medium having a computer program stored thereon, wherein the computer program is configured for performing the steps in any one of the above-mentioned method embodiments when operating.

In an exemplary embodiment, the above-mentioned computer non-transitory readable storage medium may include, but not limited to: various media, such as a U-disk, a Read-Only Memory (ROM), a Random Access Memory (RAM), a mobile hard disk, a diskette or a compact disc, capable of storing the computer program.

An embodiment of the present application further provides an electronic device, including a memory and a processor, the memory having a computer program stored thereon, and the processor being configured for operating the computer program so as to perform the steps in any one of the above-mentioned method embodiments.

In an exemplary embodiment, the above-mentioned electronic device may further include a transmission device and an input/output device, wherein the transmission device is connected to the above-mentioned processor, and the input/output device is connected to the above-mentioned processor.

Examples in this embodiment may refer to examples described in the above-mentioned embodiments and exemplary implementations, and this embodiment will be no longer repeated herein.

Apparently, it should be understood by the skilled in the art that all the above-mentioned modules or steps in the present application might be implemented by using a general-purpose calculation apparatus, they might be integrated on a single calculation apparatus or distributed on a network composed of a plurality of calculation apparatuses, and might be implemented by using program codes executable for the calculation apparatuses, whereby they might be stored in the calculation apparatuses and performed by the calculation apparatuses, and in some cases, the shown or described steps might be performed in an order different from that described here, or they are respectively made into various integrated circuit modules, or a plurality of modules or steps of them are made into a single integrated circuit module for implementation. Thus, the present application is not limited to any specific hardware and software combination.

The above descriptions are only optional embodiments of the present application, but are not intended to limit the present application. Various alterations and changes might be made to the present application by those skilled in the art. Any modifications, equivalent substitutions, improvements and the like made within the principle of the present application shall fall within the protection scope of the present application.

1. A data message transmission control method, being applied to an Ethernet virtual private network, and the method comprising:
acquiring a plurality of target provider edges connected to a same customer edge;
generating a load balancing instruction for each target provider edge amongst the plurality of target provider edges, wherein the load balancing instruction is used for instructing each target provider edge to forward, according to message information carried by received data messages to be transmitted and the load balancing instruction, target data messages matched with each target provider edge amongst the data messages to be transmitted, and the data messages to be transmitted belong to a same virtual local area network, wherein the message information is obtained by extracting a VXLAN header field from the data message to be transmitted to acquire an original message data, and performing a hash operation on the original message data; and
issuing the load balancing instruction to the corresponding target provider edges, wherein the target provider edges are configured for forwarding the target data messages to the customer edge by using the load balancing instruction received; wherein
the acquiring a plurality of target provider edges connected to a same customer edge comprises: acquiring all provider edges connected to the customer edge as candidate provider edges; and screening the plurality of target provider edges from the candidate provider edges according to a link state of each candidate provider edge of the candidate provider edges, wherein the link state is a network state of a connecting link between the candidate provider edge and the customer edge;
the generating a load balancing instruction for each target provider edge amongst the plurality of target provider edges comprises: generating a target number of load balancing tokens, wherein the target number is a number of the plurality of target provider edges; and generating the load balancing instruction carrying the target number and the load balancing tokens, wherein the load balancing instruction is used for instructing each target provider edge to forward, according to message information carried by the received data messages to be transmitted, the target number and the load balancing tokens, target data messages matched with the load balancing tokens amongst the data messages to be transmitted;
the generating a target number of load balancing tokens comprises: determining the number of the plurality of target provider edges to obtain the target number M; and generating a natural number ranging from 0 to M-1 as the target number of the load balancing tokens;
the target provider edges are configured for determining message identifiers according to the message information and the target number carried in the load balancing instruction; matching the message identifiers with the load balancing tokens carried in the load balancing instruction; and determining the data messages to be transmitted as the target data messages under a condition that the message identifiers are successfully matched with the load balancing tokens; and
the target provider edges are configured for calculating remainders obtained by dividing the message information by the target number as the message identifiers; comparing the remainders with the load balancing tokens; and determining, under a condition that the remainders are consistent with the load balancing tokens by comparison, that the message identifiers are successfully matched with the load balancing tokens.

2. (canceled)

3. The method according to claim 1, wherein the screening the plurality of target provider edges from the candidate provider edges according to a link state of each candidate provider edge of the candidate provider edges comprises:
determining a link parameter corresponding to the candidate provider edge as the link state according to network parameters reported by the candidate provider edge, and the smaller the link parameter is, the better the link state is; and
screening corresponding provider edges with link parameters being smaller than or equal to a parameter threshold as the plurality of target provider edges from the candidate provider edges.

4. The method according to claim 3, wherein the determining a link parameter corresponding to the candidate provider edge as the link state according to network parameters reported by the candidate provider edge comprises:
receiving the network parameters reported by the candidate provider edge based on a mirrored message, wherein the network parameters comprise: a bandwidth utilization rate, a latency, a jitter and a packet loss rate; and
calculating a weighted sum of the network parameters as the link parameter, wherein a weight of each network parameter of the network parameters is directly proportional to a degree of impact of the network parameter on the network state.

5. The method according to claim 4, wherein the receiving the network parameters reported by the candidate provider edge based on a mirrored message comprises one of following steps:
receiving the network parameters reported by the candidate provider edge based on the mirrored message and according to a target period;
sending a reporting instruction to the candidate provider edge; and receiving the network parameters reported by the candidate provider edge in response to the reporting instruction and based on the mirrored message.

6. The method according to claim 1, wherein the acquiring all provider edges connected to the customer edge as candidate provider edges comprises:
receiving an Ethernet network segment number reported, based on a start message, by each provider edge of the provider edges that has established communication connection; and
determining provider edges having an identical Ethernet network segment number as all the provider edges connected to the same customer edge to obtain the candidate provider edges.

7.-8. (canceled)

9. The method according to claim 1, wherein the issuing the load balancing instruction to the corresponding target provider edges comprises:
packaging the load balancing instruction as a signaling message; and
issuing the signaling message to the corresponding target provider edges.

10.-11. (canceled)

12. A data message transmission control method, being applied to target provider edges in an Ethernet virtual private network, and the method comprising:
receiving data messages to be transmitted, wherein the data messages to be transmitted belong to a same virtual local area network;
extracting message information from the data messages to be transmitted;
acquiring, according to the message information and a load balancing instruction, target data messages matched with the target provider edges amongst the data messages to be transmitted, wherein the load balancing instruction is generated and issued by a monitoring server of the Ethernet virtual private network; and
forwarding the target data messages to a customer edge connected to the target provider edges; wherein
the load balancing instruction is generated and issued by the monitoring server of the Ethernet virtual private network according to following steps:
acquiring all provider edges connected to the customer edge as candidate provider edges; screening the plurality of target provider edges from the candidate provider edges according to a link state of each candidate provider edge, wherein the link state is a network state of a connecting link between each candidate provider edge and the customer edge; generating a target number of load balancing tokens, wherein the target number is a number of the plurality of target provider edges; and generating the load balancing instruction carrying the target number and the load balancing tokens, wherein the load balancing instruction is used for instructing each target provider edge to forward, according to message information carried by received data messages to be transmitted, the target number and the load balancing tokens, target data messages matched with the load balancing tokens amongst the data messages to be transmitted;
the generating a target number of load balancing tokens comprises: determining a number of the plurality of target provider edges to obtain the target number M; and generating a natural number ranging from 0 to M-1 as the target number of the load balancing tokens;
the acquiring, according to the message information and a load balancing instruction, target data messages matched with the target provider edges amongst the data messages to be transmitted comprises: determining message identifiers according to the message information and a target number carried in the load balancing instruction; matching the message identifiers with load balancing tokens carried in the load balancing instruction; and determining the data messages to be transmitted as the target data messages under a condition that the message identifiers are successfully matched with the load balancing tokens;
the determining message identifiers according to the message information and a target number carried in the load balancing instruction comprises: calculating remainders obtained by dividing the message information by the target number as the message identifiers, wherein the message information is obtained by performing a hash operation on original message data in the data messages to be transmitted; and the matching the message identifiers with load balancing tokens carried in the load balancing instruction comprises: comparing the remainders with the load balancing tokens; and determining, under a condition that the remainders are consistent with the load balancing tokens by comparison, that the message identifiers are successfully matched with the load balancing tokens; and
the extracting message information from the data messages to be transmitted comprises: extracting original message data following a VXLAN header field from the data messages to be transmitted; and performing the hash operation on the original message data to obtain the message information.

13.-14. (canceled)

15. The method according to claim 12, wherein after the matching the message identifiers with load balancing tokens carried in the load balancing instruction, the method further comprises:
discarding the data messages to be transmitted under a condition that the message identifiers fail to be matched with the load balancing tokens.

16. The method according to claim 12, wherein before the acquiring, according to the message information and a load balancing instruction, target data messages matched with the target provider edges amongst the data messages to be transmitted, the method further comprises:
reporting network parameters to the monitoring server based on a mirrored message, wherein the network parameters comprise at least one of following parameters: a bandwidth utilization rate, a latency, a jitter or packet loss rate; and
receiving the load balancing instruction issued by the monitoring server in response to the network parameters and based on a signaling message.

17. The method according to claim 16, wherein the reporting network parameters to the monitoring server based on a mirrored message comprises one of the following steps:
reporting the network parameters based on the mirrored message and according to a target period;
receiving a reporting instruction sent by the monitoring server; and making a response to the reporting instruction to report the network parameters based on the mirrored message.

18. The method according to claim 12, wherein before the acquiring, according to the message information and a load balancing instruction, target data messages matched with the target provider edges amongst the data messages to be transmitted, the method further comprises:
establishing communication connection with the monitoring server; and
reporting an Ethernet network segment number to the monitoring server based on a start message.

19.-21. (canceled)

22. A data message transmission control system, being applied to an Ethernet virtual private network, and the system comprising a monitoring server of the Ethernet virtual private network and a plurality of provider edges,
the monitoring server being respectively connected to the plurality of provider edges, and the plurality of provider edges being connected to a same customer edge;
the monitoring server being configured for acquiring a plurality of target provider edges amongst the plurality of provider edges; generating a load balancing instruction for each target provider edge amongst the plurality of target provider edges, wherein the load balancing instruction is used for instructing the target provider edge to forward, according to message information carried by received data messages to be transmitted and the load balancing instruction, a target data message matched with the target provider edge amongst the data messages to be transmitted, and the data messages to be transmitted belong to a same virtual local area network; and issuing the load balancing instructions to the corresponding target provider edges;
the target provider edges being configured for receiving data messages to be transmitted, wherein the data messages to be transmitted belong to the same virtual local area network;
extracting message information from the data messages to be transmitted; acquiring, according to the message information and the load balancing instruction, target data messages matched with the target provider edges amongst the data messages to be transmitted; and forwarding the target data messages to the customer edge;
the monitoring server being further configured for: acquiring all provider edges connected to the customer edge as candidate provider edges; and screening the plurality of target provider edges from the candidate provider edges according to a link state of each candidate provider edge of the candidate provider edges, wherein the link state is a network state of a connecting link between the candidate provider edge and the customer edge;
the monitoring server being further configured for: generating a target number of load balancing tokens, wherein the target number is the number of the plurality of target provider edges; and generating the load balancing instruction carrying the target number and the load balancing tokens, wherein the load balancing instruction is used for instructing each target provider edge to forward, according to message information carried by the received data messages to be transmitted, the target number and the load balancing tokens, target data messages matched with the load balancing tokens amongst the data messages to be transmitted;
the monitoring server being further configured for: determining the number of the plurality of target provider edges to obtain the target number M; and generating a natural number ranging from 0 to M-1 as the target number of the load balancing tokens;
the target provider edges being further configured for: determining message identifiers according to the message information and the target number carried in the load balancing instruction; matching the message identifiers with the load balancing tokens carried in the load balancing instruction; and determining the data messages to be transmitted as the target data messages under the condition that the message identifiers are successfully matched with the load balancing tokens;
the target provider edges being further configured for: calculating remainders obtained by dividing the message information by the target number as the message identifiers, wherein the message information is obtained by performing a hash operation on original message data in the data messages to be transmitted; and the target provider edges being further configured for: comparing the remainders with the load balancing tokens; and determining, under a condition that the remainders are consistent with the load balancing tokens by comparison, that the message identifiers are successfully matched with the load balancing tokens; and
the target provider edges being further configured for: extracting original message data following a VXLAN header field from the data messages to be transmitted; and performing the hash operation on the original message data to obtain the message information.

23.-24. (canceled)

25. A computer non-transitory readable storage medium, wherein the computer non-transitory readable storage medium has a computer program stored thereon, wherein the computer program is configured to implement the steps of the method according to claim 1 when executed by a processor.

26. An electronic device, comprising a memory, a processor, and a computer program stored on the memory and capable of operating on the processor, wherein the processor is configured to implement the steps of the method according to claim 1 when executing the computer program.

27. The method according to claim 3, wherein the network parameters comprise at least one of following parameters: a bandwidth utilization rate, a latency, a jitter or a packet loss rate.

28. The method according to claim 17, wherein the mirrored message is sampled at one time within a certain sampling period, the certain sampling period is adjustable.

29. The method according to claim 17, wherein the target period is used for instructing a time interval of two adjacent times when the candidate provider edges report the network parameters collected based on the mirrored message to the monitoring server, and the target period is adjustable.

30. The method according to claim 18, wherein the establishing communication connection with the monitoring server comprises:
configuring the customer edge and the provider edges with a same monitoring server; and
establishing, by the provider edges, a Border Gateway Protocol (BGP) neighbor relationship with the monitoring server concurrently with establishing BGP neighbor relationships among themselves.

31. The method according to claim 30, wherein the provider edges and the monitoring server are configured to process message data comprising, start messages, mirrored messages, and signaling messages.

32. The method according to claim 28, wherein the certain sampling period is 300 s or 400 s.
